(19) United States
(12) Patent Application Publication
(10) Pub. No.: US 2005/0186427 A1
(43) Pub. Date: Aug. 25, 2005

(54) Lubricious coated applicator

(75) Inventor: Joseph Anthony Gatto, Deerfield Twp., OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/782,041

(22) Filed: Feb. 19, 2004

(51) Int. Cl. B05D 3/02; B05D 7/00; B05D 1/18; B32B 27/00

(52) U.S. Cl. 428/411.1; 427/384; 427/430.1; 427/421.1; 604/904

(57) ABSTRACT

A method and a coating on a tampon applicator. The coating includes a crosslinked hydrogel that includes a copolymer including water soluble base polymers having graft polymerized thereto organic moieties that react with water to form a silanol group. The copolymer is crosslinked through the silanol groups of the organic moieties to form a coating that is absorbent, lubricious and substantially non-water soluble.

### FIELD OF THE INVENTION

The present invention relates to an absorbent, lubricious coating, and more particularly to an absorbent, lubricious coating which is water insoluble and is formed from a modified water soluble base polymer that crosslinks upon exposure to moisture.

### BACKGROUND OF THE INVENTION

Coatings that are water absorbent and lubricious are useful in medical applications such as coatings for surgical instruments, for in-dwelling biomaterials such as stents, screws and internal splints, and for tubing, catheters, wire guides and the like. Such coatings minimize the trauma of contact of the article with tissues and biological fluids. In particular, such coatings are particularly useful in fabrics and bandages that contact cuts and abrasions to provide coated fabrics and bandages that can absorb excess wound fluid without irritating exposed tissue.

Other products, such as tampon applicators are also great conveniences that depend upon characteristics of absorbency and biological inertness. However, these products are disposed of after a single use and most often ultimately are deposited into a landfill. If such products are made of non-biodegradable material, they persist in the landfill and can limit the later use of the landfill area while continuing to occupy space in the fill. Accordingly, it would be advantageous if the materials that comprise these disposable products were biodegradable.

Approaches that have been used in the past to provide materials that are lubricious and absorbent include the production of laminates having a porous non-stick surface backed by an absorbent pad, the synthesis of fibers and fabrics from absorbent, lubricious materials, and the formation of absorbent coatings on structurally durable, but non-absorbent materials. However, each type of structure has encountered its own particular problems. For example, laminates formed by bonding absorbent coatings to non-absorbent materials often delaminate or are impossible to bond together at all. Fibers and films produced from lubricious, absorbent compounds often have low strength and lack of integrity and durability.

Recent development efforts have provided materials that show promise for the types of uses described above and have improved processibility characteristics, and often, increased strength and durability. For example, in U.S. Pat. No. 6,054,523, Braun et al., describe materials that are formed from organopolysiloxanes containing groups that are capable of condensation, a condensation catalyst, an organopolysiloxane resin, a compound containing a basic nitrogen, and polyvinyl alcohol. The materials are reported to be suitable for use as hydrophobic coatings and for paints and sealing compositions.

Other workers have reported the production of graft copolymers having silane functional groups that permitted the initiation of cross-linking by exposure to moisture. Prejean (U.S. Pat. No. 5,389,728) described a melt-processible, moisture-curable graft copolymer that was the reaction product of ethylene, a 1-8 carbon alkyl acrylate or methacrylate, a glycidyl containing monomer such as glycidyl acrylate or methacrylate, onto which has been grafted N-tert-butylaminopropyl trimethoxysilane. The resulting copolymers were reported to be useful as adhesives and for wire and cable coatings, however, would not be expected that such materials would be either water-absorbent or lubricious when wet.

Furrer et al. (U.S. Pat. No. 5,112,919) reported a moisture-crosslinkable polymer that was produced by blending a thermoplastic base polymer, such as polyethylene, or a copolymer of ethylene, with 1-butene, 1-hexene, -octene, or the like; a solid carrier polymer, such as ethylene vinylacetate copolymer (EVA), containing a silane, such as vinyltrimethoxysilane; and a free-radical generator, such as an organic peroxide; and heating the mixture. The copolymers could then be cross-linked by reaction in the presence of water and a catalyst, such as dibutyltin dilaurate, or stannous octoate.

Keough (U.S. Pat. No. 4,593,071) reported moisture cross-linkable ethylene copolymers having pendant silane acryloxy groups. The resultant cross-lined polymers were reported to be especially resistant to moisture and to be useful for extruded coatings around wires and cables. The same group has reported water similar moisture curable polymers involving silanes in U.S. Pat. Nos. 5,047,476,4,767,820, 4,753,993, 4,579,913, 4, 575,535,4,551,504, 4,526,930, 4,493,924, 4,489,029,4,446,279, 4,440,907,4,434,272,4,408,011, 4,369,289, 4,353,997, 4,343,917,4,328,323, and 4,291,136. Since the cured products of these formulations are reported to be useful for coverings for wire and cable, and for non-conductive coatings for electrical conductors, it would be expected that they are durable coatings for which properties such as water absorbency and biodegradability would be a disadvantage.

Water-swellable polymers have reportedly been produced by cross-linking water soluble polymers, such as poly(ethylene oxide). It is known that poly(alkylene oxides), such as poly(ethylene oxide), can be cross-linked through gamma irradiation. Depending upon the degree of irradiation and the degree of cross-linking, the properties of the cross-linked polymer can range from a water soluble material to a hard solid with no appreciable water absorbency. Materials that are substantially non-water soluble, but still absorbent can be made. However, the use of gamma rays requires expensive equipment and time consuming procedures due to safety concerns, and the degree of cross-linking that is obtained is often difficult to control.

Several references have reported the use of chemical cross-linking groups as a method of avoiding the dangers and costs associated with the use of ionizing radiation. Chu (U.S. Pat. No. 3,963,605) reported a water-swellable, cross-linked poly(alkylene oxide) that was produced by h mixture of poly(ethylene oxide) with acrylic acid and a free radical initiator such as acetyl peroxide in a hydrocarbon solvent such as hexane, heptane, or cyclohexane. Another alternative was reported in Canadian Pat. No. 756,190, and involved cross-linking through a di-vinyl monomer in the presence of a free radical catalyst. The use of other cross-linking agents, such as a diacrylate, or methyl-bis-acrylamide with a free radical inhibitor, has also been reported.

Lubricious coatings of cross-linked, hydrophilic polyurethane have been reported by Watson in U.S. Pat. No. 6,020,071. Another polyurethane coating is described by Tedeshchl et al., in EP 0992 252 A2, where a lubricious, drug-accommodating coating is described that is the product of a polyisocyanate; an amine donor, and/or hydroxyl donor; and an isocyanatosilane adduct having terminal isocyanate groups and an alkoxy silane. A water soluble polymer, such as poly(ethylene oxide), can optionally be present. Cross-linking causes a polyurethane or a polyurea network to form, depending upon whether the isocyanate reacts with the hydroxyl donors or the amine donors.

Despite these advances, there is still a need for a method to form a durable and plastic-like coating on a tampon applicator where the coating is adherent to the tampon applicator and yet has a high degree of water absorbency when contacted with an aqueous fluid. There is a particular need for such coatings that are biologically inert and nontoxic, are lubricious when moist, and can be formed under conditions that do not require irradiation or extreme temperatures. There is a need for consumers to have available a tampon applicator that provides a smooth and comfortable insertion and/or withdrawal of the tampon. It is to such needs that the present invention is directed.

### SUMMARY OF THE INVENTION

Te present invention is directed to a novel method of forming a coating on a tampon applicator, the method comprising contacting the tampon applicator with a copolymer comprising a water soluble base polymer having graft polymerized thereto an organic moiety that includes a group that reacts with water to form a silanol group; and curing the copolymer to form a coating comprising the crosslinked copolymer on the tampon applicator.

The present invention is also directed to a novel coating on a tampon applicator, the coating comprising a crosslinked hydrogel that includes a copolymer comprising water soluble base polymers having graft polymerized thereto organic moieties that react with water to form a silanol group, the copolymer being crosslinked through the silanol groups of the organic moieties to form a coating that is absorbent, lubricious and substantially non-water soluble.

The present invention is also directed to a novel coated tampon applicator comprising a tampon applicator coated with a crosslinked hydrogel that includes a copolymer comprising water soluble base polymers having graft polymerized thereto organic moieties that react with water to form a silanol group, the copolymer being crosslinked through the silanol groups of the organic moieties to form a coating that is absorbent, lubricious and substantially non-water soluble.

The present invention is also directed to a novel coating solution comprising a mixture of a solvent and a copolymer comprising a water soluble base polymer having graft polymerized thereto an organic moiety that includes a group that reacts with water to form a silanol group.

Among the several advantages found to be achieved by the present invention, therefore, may be noted the provision of a method to form a durable and plastic-like coating on a tampon applicator where the coating is adherent to the tampon applicator and yet has a high degree of water absorbency when contacted with an aqueous fluid, and the provision of such a coating that is biologically inert and nontoxic, and is lubricious when moist, and can be formed under conditions that do not require irradiation or extreme temperatures.

### DETAILED DESCRIPTION OF THE INVENTION

As used herein “applicator” refers to a device or implement that facilitates the insertion of a tampon, medicament, treatment device, visualization aid, or other into an external orifice of a mammal, such as the vagina, rectum, ear canal, nasal canal, or throat. Non-limiting specific examples of such include any known hygienically designed applicator that is capable of receiving a tampon may be used for insertion of a tampon, including the so-called telescoping, tube and plunger, and the compact applicators, an applicator for providing medicament to an area for prophylaxis or treatment of disease, a spectroscope containing a microcamera in the tip connected via fiber optics, a speculum of any design, a tongue depressor, a tube for examining the ear canal, a narrow hollow pipe for guiding surgical instruments, and the like.

As used herein, the term “tampon,” refers to any type of absorbent structure that is inserted into the vaginal canal or other body cavities for the absorption of fluid therefrom, to aid in wound healing, or for the delivery of active materials, such as medicaments, or moisture. The tampon may be compressed into a generally cylindrical configuration in the radial direction, axially along the longitudinal axis or in both the radial and axial directions. While the tampon may be compressed into a substantially cylindrical configuration, other shapes are possible. These may include shapes having a cross section that may be described as rectangular, triangular, trapezoidal, semi-circular, hourglass, serpentine, or other suitable shapes. Tampons have an insertion end, withdrawal end, a length, a width, a longitudinal axis, a radial axis and an outer surface. The tampon's length can be measured from the insertion end to the withdrawal end along the longitudinal axis. A typical compressed tampon for human use is 30-60 mm in length. A tampon may be straight or non-linear in shape, such as curved along the longitudinal axis. A typical compressed tampon is 8-20 mm wide. The width of a tampon, unless otherwise stated in the specification, corresponds to the length across the largest cylindrical cross-section, along the length of the tampon.

The term “vaginal cavity,” “within the vagina,” and “vaginal interior,” as used herein, are intended to be synonymous and refer to the internal genitalia of the mammalian female in the pudendal region of the body. The term “vaginal cavity” as used herein is intended to refer to the space located between the introitus of the vagina (sometimes referred to as the sphincter of the vagina or hymeneal ring,) and the cervix. The terms “vaginal cavity,” “within the vagina” and “vaginal interior,” do not include the interlabial space, the floor of vestibule or the externally visible genitalia.

In accordance with the present invention, it has been discovered that an absorbent, lubricious, substantially non-water soluble coating can be placed on various articles by contacting the article with a solution of a copolymer comprising a water soluble base polymer having graft polymerized thereto an organic moiety that includes a group that reacts with water to form a silanol group, and then curing the copolymer to form a coating on the article that comprises the crosslinked copolymer. Coating solutions that include the copolymer and articles that have been coated with the novel coating are also included in the scope of the invention, as is the actual coating itself.

An important property of the coating is that it can be applied to almost any article without the use of dangerous ionizing radiation, or the exposure of the article to conditions of biologically irritating high or low pH values. In fact, the curing can be done by simply exposing the copolymer to moisture and then, in one embodiment, removing the moisture to form the crosslinked coating.

Application of the coating to articles is easily done and provides materials having the dual advantage of high structural strength plus the property of being highly absorbent and lubricious.

If it is desirable, various materials such as therapeutic agents, can be included in the coating as releasable components. With this feature, the coating is adapted to act as a controlled release matrix for the releasable component, and to release the component for contact with, for example, a wound bed upon which a dressing containing the novel coating has been placed.

A copolymer that is useful for the present coating comprises a graft copolymer of a water soluble base polymer to which is engrafted an amount of an organic moiety that includes a group that reacts with water to form a silanol group. Suggested water-soluble base polymers useful in the present invention include, but are not limited to, poly(alkylene oxides), such as poly(ethylene oxide) (“PEO”), poly(ethylene glycols), block copolymers of ethylene oxide and propylene oxide, poly(vinyl alcohol) and poly(alkyl vinyl ethers). These water-soluble base polymers are capable of graft polymerization with an organic moiety containing a trialkoxy silane functional group or another such moiety that reacts with water to form a silanol group. One particularly useful water-soluble base polymer for use in the present invention is PEO. A process for the graft polymerization of PEO with methacryloxypropyl trialkoxy silane followed by cross-linking upon exposure to moisture is shown below.

Since crosslinking of a silane graft-modified PEO does not normally occur during thermal processing, the graft-modified PEO that is useful for the coatings of the present invention provides for more robust thermal processing into functional forms. Furthermore, since the process of forming a silane graft-modified PEO does not require the use of aqueous solutions, there are no costly and time consuming evaporation steps involved.

Desirable water soluble base polymers and resins useful for graft modification for use in coatings in accordance with the present invention include, but are not limited to, PEO resins having initial reported approximate molecular weights ranging from about 10,000 g/mol to about 8, 000,000 g/mol as determined by rheological measurements. Such PEO resins are commercially available from, for example, Union Carbide Corporation having offices in Danbury, Conn., and are sold under the trade designations POLYOX® 205, POLYOX® N-10, POLYOX® N-80, POLYOX® WSR N-750, POLYOX® WSR N-12K and POLYOX® UCARFLOC® Polymer 309.

The coatings of the present invention can be made from commercially available PEO resins when modified as described herein. The PEO resins useful for the subject coatings include, but are not limited to, PEO resins having initial reported approximate molecular weights ranging from about 50,000 g/mol to about 600,000 g/mol. Higher molecular weights are desired for increased mechanical and physical properties and lower molecular weights are desired for ease of processing. Desirable PEO resins for use in coatings have molecular weights ranging from 50,000 to 600,000 g/mol before modification and more desired PEO resins have molecular weights ranging from 50,000 to 300,000 g/mol before modification. The PEO compositions modified from PEO resins within the above resins provide desirable balances between mechanical and physical properties and processing properties. Four PEO resins within the above preferred ranges are commercially available from Union Carbide Corporation and are sold under the trade designations POLYOX® N-205, POLYOX® N-750, POLYOX® WSR N-10 and POLYOX® WSR N-80. These four resins have reported approximate molecular weights, as determined by Theological measurements, of about 100,000 g/mol to 600,000 g/mol.

Other PEO resins available from, for example, Union Carbide Corporation, within the above approximate molecular weight ranges are sold under the trade designations WSR N-750, WSR N-3000, WSR-3333, WSR-N-12K, WSR-N-60K, WSR-301, WSR Coagulant POLYOX®: Water Soluble Resins, Union Carbide Chemicals & Plastic Company, Inc. (1991). Both PEO powder and pellets of PEO can be used in this invention since the physical form of PEO does not affect its behavior in the melt state for grafting reactions. This invention has been demonstrated by the use of PEO in powder form as supplied by Union Carbide. However, the PEO resins to be modified may be obtained from other suppliers and in other forms, such as pellets. The PEO resins and modified compositions may optionally contain various additives, such as, plasticizers, processing aids, rheology modifiers, antioxidants, UV light stabilizers, pigments, colorants, slip additives, antiblock agents, etc., which may be added before or after modification.

Organic monomers capable of graft polymerization with the water soluble base polymers described above and which also contain a functional group or moiety that reacts with water to form a silanol group are useful for the synthesis of copolymers that can be used to form the coatings of the present invention. One such functional group that can react with water to form a silanol group is a trialkoxy silane functional group. The trialkoxy silane functional group can have the following structure: wherein R1, R 2 and R 3 are the same or different alkyl group, each independently having 1 to 6 carbon atoms.

The term “monomer(s)” as used herein includes monomers, oligomers, polymers, mixtures of monomers, oligomers and/or polymers, and any other reactive chemical species which is capable of covalent bonding with the parent polymer, PEO. Ethylenically unsaturated monomers containing a trialkoxy silane functional group are appropriate for this invention and are desired. Desired ethylenically unsaturated monomers include acrylates and methacrylates. A particularly desirable ethylenically unsaturated monomer containing a trialkoxy silane functional group is methacryloxypropyl trimethoxy silane. Methacryloxypropyl trimethoxy silane is commercially available from Dow Corning, having offices in Midland, Mich., under the trade designation Z-6030 Silane. Other suitable ethylenically unsaturated monomers containing a trialkoxy silane functional group include, but are not limited to, methacryloxyethyl trimethoxy silane, methacryloxypropyl triethoxy silane, methacryloxypropyl tripropoxy silane, acryloxypropylmethyl dimethoxy silane, 3-acryloxypropyl trimethoxy silane, 3-methacryloxypropylmethyl diethoxy silane, 3-methacryloxypropylmethyl dimethoxy silane, and 3-methacryloxypropyl tris(methoxyethoxy) silane. However, it is contemplated that a wide range of vinyl and acrylic monomers having trialkoxy silane functional groups or a moiety that reacts easily with water to form a silanol group, such as a chlorosilane or an acetoxysilane, provide the desired effects to PEO and are effective monomers for grafting in accordance with the copolymers that are useful in the coatings and methods of the present invention.

The amount of organic monomer having trialkoxy silane functional groups or silanol-forming functional groups relative to the amount of PEO may range from about 0.1 to about 20 weight percent of monomer to the weight of PEO. Desirably, the amount of monomer should exceed 0.1 weight percent in order sufficiently to improve the processability of the PEO. A range of grafting levels is demonstrated in the Examples. Typically, the monomer addition levels are between about 0.25% and about 15% of the weight of the base PEO resin; particularly, between about 0.5% and about 10% of the weight of the base PEO resin; and especially, between about 1.5% and about 6.0% of the weight of the base PEO resin.

A variety of initiators may be useful in forming the graft copolymer from the water soluble base polymer and the monomer. When grafting is achieved by the application of heat, as in a reactive-extrusion process, it is desirable that the initiator generates free radicals through the application of heat. Such initiators are generally referred to as thermal initiators. For the initiator to function as a useful source of radicals for grafting, the initiator should be commercially and readily available, stable at ambient or refrigerated conditions, and generate radicals at reactive-extrusion temperatures.

Compounds containing an O—O, S—S, or N═N bond may be used as thermal initiators. Compounds containing O—O bonds; i.e., peroxides, are commonly used as initiators for graft polymerization. Such commonly used peroxide initiators include: alkyl, dialkyl, diaryl and arylalkyl peroxides such as cumyl peroxide, t-butyl peroxide, di-t-butyl peroxide, dicumyl peroxide, cumyl butyl peroxide, 1, 1-di-t-butyl peroxy-3,5,5-trimethylcyclohexane, 2,5-dimethyl-2,5-di(t-butylperoxy)hexane, 2,5-dimethyl-2,5-bis(t-butylperoxy)hexyne-3 and bis(a-t-butyl peroxyisopropylbenzene); acyl peroxides such as acetyl peroxides and benzoyl peroxides; hydroperoxides such as cumyl hydroperoxide, t-butyl hydroperoxide, p-methane hydroperoxide, pinane hydroperoxide and cumene hydroperoxide; peresters or peroxyesters such as t-butyl peroxypivalate, t-butyl peroctoate, t-butyl perbenzoate, 2,5-dimethylhexyl-2,5-di(perbenzoate) and t-butyl di(perphthalate); alkylsulfonyl peroxides; dialkyl peroxymonocarbonates; dialkyl peroxydicarbonates; diperoxyketals; ketone peroxides such as cyclohexanone peroxide and methyl ethyl ketone peroxide. Additionally, azo compounds such as 2,2′-azobisisobutyronitrile abbreviated as AIBN, 2,2′-azobis(2,4-dimethylpentanenitrile) and 1,1′-azobis(cyclohexanecarbonitrile) may be used as the initiator. Graft copolymers that are useful in the subject coatings have been demonstrated in the following Examples by the use of a liquid, organic peroxide initiator available from R. T. Vanderbilt Company, Inc. of Norwalk, Conn., sold under the trade designation VAROX DBPH peroxide which is a free radical initiator and comprises 2,5-bis(tert butylperoxy)-2,5-dimethyl hexane along with smaller amounts of di(tert butylperoxide). Other initiators may also be used, such as LUPERSOL® 101 and LUPERSOL® 130 available from Elf Atochem North America, Inc. of Philadelphia, Pa.

A variety of reaction vessels may be useful to produce the copolymers useful for the subject coatings. The modification of the PEO can be performed in any vessel as long as the necessary mixing of PEO, the monomer and the initiator is achieved and enough thermal energy is provided to affect grafting. Desirably, such vessels include any suitable mixing device, such as Brabender Plasticorders, Haake extruders, Bandbury mixers, single or multiple screw extruders, or any other mechanical mixing devices which can be used to mix, compound, process or fabricate polymers. One useful reaction device is a counter-rotating twin-screw extruder, such as a Haake extruder available from Haake, 53 West Century Road, Paramus, N.J. 07652. Another is a co-rotating, twin-screw extruder, such as a ZSK-30 twin-screw, compounding extruder manufactured by Wemer & Pfleiderer Corporation of Ramsey, N.J. It should be noted that a variety of extruders may be used to modify the PEO provided that sufficient mixing and heating occur.

The inventors have discovered that the copolymers described above can be used to form a coating on a tampon applicator, the method involves contacting the tampon applicator with a copolymer of a water soluble base polymer having graft polymerized thereto an organic moiety that includes a group that reacts with water to form a silanol group; and curing the copolymer to form a coating comprising the crosslinked copolymer on the tampon applicator.

In one embodiment, the method for contacting a tampon applicator to be coated with the copolymers described above is to form a solution of the copolymer in a solvent and place a film of solution on the tampon applicator. As that term is used herein, “solution” should be understood to include true solutions, emulsions and dispersions.

It is believed that this coating solution is also within the scope of the present invention. The coating solution comprises a mixture of a solvent and a copolymer comprising a water soluble base polymer having graft polymerized thereto an organic moiety that includes a group that reacts with water to form a silanol group. The water soluble base polymers and organic moieties that are useful for the present coating solutions include those that have been discussed above. In particular, solutions containing poly(ethylene oxide) engrafted with 3-methacryloxypropyl tris(methoxyethoxy) silane have been found to be desirable.

When the copolymer is placed into solution in a solvent, it is believed that almost any liquid can be used. It is desirable that the liquid be an organic solvent, such as an alcohol, ketone, aldehyde, alkane, alkene, aromatic, or mixture thereof, or be water. Water can also be used in combination with an organic solvent. When a mixture of water and an organic solvent is used as the solvent, the water should be present in an amount of from about 5% to about 100% by weight. It is desirable that pure water be used as the solvent.

Variable amounts of the copolymer can be used to form the solution. It is believed that solutions containing from about 0.1% to about 10% by weight of the copolymer can be used, and solutions containing about 1% to about 8% by weight are desirable.

After the copolymer has been placed into solution in a solvent, the solution is then contacted with the tampon applicator to be coated so as to place a film of the solution on the tampon applicator. This can be done by dipping, spraying, printing, painting, or immersing the tampon applicator with or in the solution. A common way to apply the film to the tampon applicator is to simply dip the tampon applicator into the solution and allow any excess solution to drain from the tampon applicator. This step can be carried out once, or it may be repeated any number of times. If desirable, the copolymer in the film may be cured after a film has been applied, and then the application of another film of the copolymer may be repeated in order to build up a coating of the desired thickness.

After a film of the solution containing the copolymer has been applied to the tampon applicator, the copolymer is cured to form a cross-linked hydrogel coating. The copolymer can be cured by removing solvent from the copolymer. One method of removing liquid that results in curing the copolymer is to evaporate the solvent. A common method for carrying out the evaporation is by drying the tampon applicator. Such drying is commonly done in air under ambient conditions, but the tampon applicator can be placed in an oven or other temperature and/or humidity controlled space in order to control the drying. As the solvent is removed from the film, silanol groups of adjacent copolymers form bonds to cross-link the structure into a hydrogel.

As an alternative, removal of the solvent can be carried out by any method, such as, for example, absorption, chelation, sequestration or chemical reaction.

In an alternative method, the coating can be applied to the tampon applicator by applying a film of liquid to the tampon applicator, where the film contains the copolymer in un-crosslinked form. This can be done by melting the copolymer and applying the molten copolymer to the tampon applicator to form the film. Alternatively, the copolymer may be dispersed in a non-aqueous solvent to form a dispersion or emulsion, and the dispersion or emulsion can be applied to the tampon applicator to form the film.

When the un-crosslinked copolymer is used to form a film on a tampon applicator it is normally desirable that this be carried out under substantially water-free conditions in order to avoid premature cross-linking of the copolymer. In fact, it is often desirable that the film be applied under conditions that are substantially anhydrous.

It is normal for the film that is applied to the tampon applicator to be coated to be applied in such a manner that it substantially covers the exterior surface of the tampon applicator. Of course, when a coating is to be placed on the interior surface of an article, it is necessary that the film also contact that surface. In fact, any surface that is to be coated should be covered by the film.

After the film containing the un-crosslinked copolymer has been applied, it can be cured by contacting the film with water. This can be done in any manner, such as dipping, spraying, misting, or exposing the tampon applicator to high humidity conditions. When it is said that the tampon applicator is to be contacted with water, any form of water is included—such as liquid water or water vapor.

One important characteristic of the curing step of the novel coating method is that it is free of the need for the use of ionizing radiation, such as gamma radiation. It can also be done at ambient temperature and pressure. Moreover, it can be carried out at normal, physiological pH values, for example, at a neutral pH, or at a pH between about 6 and about 8. Benefits of this feature include that the curing can be done while the film is in contact with a wound, and that there are no residual fluids having biologically irritating low or high pH values that could leach out of a dressing and irritate a wound.

The copolymer is cured by the method described above to form a coating on a tampon applicator, the coating comprising a crosslinked hydrogel that includes a copolymer comprising water soluble base polymers having graft polymerized thereto organic moieties that react with water to form a silanol group, the copolymer being crosslinked through the silanol groups of the organic moieties to form a coating that is absorbent, lubricious and substantially non-water soluble.

When it is said that the coating is “absorbent”, what is meant is that the coating can absorb water. As will be shown in the Examples, which follow, the present coatings are capable of absorbing their own weight in water, or even many times their own weight. It is believed that this is an advantage of the present coatings, particularly when they are used in applications where moisture absorption and control are important—such as in bandages, diapers, and the like.

When it is said that the coating is “lubricious”, it is meant that the outer surface of the coating has a smooth and slippery quality when wet.

When it is said that the coating is “substantially non-water soluble”, it is meant that the cured coating has a solubility in water at 25° C. of less than 40% by weight, desirably, less than 4% by weight.

It is believed to be desirable that the copolymer that is used to form the novel coating contains the organic moiety that is engrafted onto the water soluble base polymer in an amount that is within a range of about 0. 5 to about 10 percent by weight of the water soluble base polymer. It has been found that resins with higher grafting levels produce a stiffer gel with high lubricity and less absorbent capacity while lower grafting levels produce softer, more absorbent gels on the surface of the substrate.

In some instances, it is desirable that the coating be translucent, or even be transparent. It can then be used on lenses or windows, and can have an antifogging property so that the coated lens or window is resistant to fogging.

When the coating is used on tubing and tampon applicators that come into contact with blood and other bodily fluids, it is desirable that the coating be non-thrombogenic or anti-thrombogenic.

Another feature of the present coating is that it can act as a reservoir for releasable components that are to be delivered from the coating to a region outside of the coating, such as, for example, a wound. In this embodiment, the coating can act to provide a controlled release of such compounds as therapeutic agents, bioactive agents, antibiotics, bactericides, fungicides, drugs, growth factors, peptides, proteins, enzymes, emollients, antiseptics, anti-oxidants, wetting agents, and mixtures thereof.

Tampon applicators that have a coating as described above invention are also to be included in the present invention. Such coated tampon applicators comprise a tampon applicator coated with a crosslinked hydrogel that includes a copolymer comprising water soluble base polymers having graft polymerized thereto organic moieties that react with water to form a silanol group, the copolymer being crosslinked through the silanol groups of the organic moieties to form a coating that is absorbent, lubricious and substantially non-water soluble.

It is believed that the novel coating can be placed on almost any type of article, and useful articles include articles that are metal, glass, natural or synthetic polymer, natural fiber, wood, another coating or paint, or a mixture thereof. As noted above, the article can be a transparent lens or window. In addition, the lubricity of the subject coating can be advantageous when the coated article is the water-contacting surface of a pipe, tube, pipeline, boat hull, submarine, torpedo, fishing line, fishing lure, water ski, propeller, or any other article that carries or contacts moving water. By using the novel coating, fluid friction caused by the article moving in relation to the water can be reduced and the cost or effort of such movement can also be reduced.

The novel coating can also be applied to such articles as medical instruments, bandages, drapes, fabrics, fibers, foams, films, tubing, catheters, shunts, artificial organs, dialysis apparatus, surgical instruments, stents, indwelling splints, and guide wires.

When the coated article is a fiber, it has been found to be useful for the underlying fiber to be coated to be one that is produced from poly(propylene), poly(ethylene terephthalate), poly(lactic acid), or rayon.

However, the present invention is not limited to these or any particular polymer or material from which to form the fibers. For example, various other materials, including the following, may be used: polyethylene, polyesters, polybutane, polymethyldentene, ethylenepropylene co-polymers, polyamides, tetrablock polymers, styrenic block copolymers, polyhexamethylene adipamide, poly-(oc-caproamide), polyhexamethylenesebacamide, polyvinyls, polystyrene, polyurethanes, thermoplastic polymers, polytrifluorochloroethylene, ethylene vinyl acetate polymers, polyetheresters, polyurethane, polyurethane elastomerics, polyamide elastomerics, polyamides, viscoelastic hot melt pressure sensitive adhesives, cotton, and hemp. In addition, such materials may be utilized to extrude single-constituent, bi-constituent, and bi-component fibers, in a variety of cross-sectional shapes, which may be coated with the novel coating of the presently described invention.

Other exemplary elastomeric materials that may be used include polyurethane elastomeric materials such as those available under the trademark ESTANE from B.F. Goodrich & Co., polyamide elastomeric materials such as those available under the trademark PEBAX from the Rilsan Company, and polyester elastomeric materials such as those available under trade designation HYTREL from E.I. DuPont De Nemours & Company.

However, the fibers that are useful in the present invention are not limited to only such elastomeric materials. For example, various latent elastic materials such as the Amitel-brand polymers may be utilized to provide the necessary elasticity characteristics to the continuous filaments.

The materials utilized to form the continuous fibers may also be utilized in forming woven or non-woven fabrics that can be substrates for the novel coating. In particular, various webs may be utilized that are formed from elastomeric or nonelastomeric fibers. Various polyester elastic materials are, for example, disclosed in U.S. Pat. No. 4,741,949 to Morman et al. Other useful elastomeric polymers also include, for example, elastic copolymers of ethylene and at least one vinyl monomer such as, for example, vinyl acetates, unsaturated aliphatic monocarboxylic acids, and esters of such monocarboxylic acids. The elastic copolymers and formation of elastomeric fibers from these elastic copolymers are disclosed in, for example, U.S. Pat. No. 4,803,117.

The nonwoven fabrics that are useful in the present invention may be a mixture of elastic and nonelastic fibers or particulates. For example, U.S. Pat. No. 4,209,563 describes the process by which elastomeric and nonelastomeric fibers are commingled to form a single coherent web of randomly dispersed fibers. Another example of such an elastic composite web is shown in U.S. Pat. No. 4,741,949, wherein an elastic nonwoven material is described as including a mixture of meltblown thermoplastic fibers and other materials. The fibers and other materials may be combined in the forming gas stream in which the fibers are borne so that an intimate entangled commingling of fibers and other materials, e.g., wood pulp, staple fibers or particulates such as, for example, activated charcoal, clays, starches, or hydrocolloid (hydrogel) particulates, occurs prior to collection of the fibers upon a collecting device to form a coherent web of randomly dispersed fibers.

Various processing aids may also be added to the elastomeric polymers utilized in the present invention. For example, a polyolefin may be blended with the elastomeric polymer (e.g., the A-B-A elastomeric block copolymer) to improve the processability of the composition. The polyolefin should be one which, when so blended and subjected to an appropriate combination of elevated pressure and elevated temperature conditions, is extrudable in blended form with the elastomeric polymer. Useful blending polyolefin materials include, for example, polyethylene, polypropylene and polybutene, including ethylene copolymers, propylene copolymers and butene copolymers. A particularly useful polyethylene may be obtained from the U.S.I. Chemical Company under the trade designation Petrothene NA 601 (also referred to herein as PE NA 601 or polyethylene NA 601). Two or more of the polyolefins may be utilized. Extrudable blends of elastomeric polymers and polyolefins are disclosed in, for example, U.S. Pat. No. 4,663,220.

The elastomeric materials that are utilized to form the elastomeric filaments may have sufficient tackiness to enhance the bonding strength of the laminate by allowing a degree of autogenous bonding. For example, the elastomeric polymer itself may be tacky when formed into fibers and/or filaments or, alternatively, a compatible tackifing resin may be added to the extrudable elastomeric compositions described above to provide tackified elastomeric fibers and/or filaments that autogenously bond. Various known tackifying resins and tackified extrudable elastomeric compositions may be employed, such as those described in U.S. Pat. No. 4,787,699.

Any tackifier resin can be used that is compatible with the elastomeric polymer and can withstand the extrusion processing conditions. If the elastomeric polymer (e.g., A-B-A elastomeric block copolymer) is blended with processing aids such as, for example, polyolefins or extending oils, the tackifier resin should also be compatible with those processing aids. Generally, hydrogenated hydrocarbon resins exhibit enhanced temperature stability and, thus, may be desirable tackifiers. REGALREZ® hydrocarbon and ARKON® series tackifiers are examples of hydrogenated hydrocarbon resins. ZONATAK® 501 lite is an example of a terpene hydrocarbon. REGALREZ® hydrocarbon resins are available from Hercules Incorporated. ARKON® series resins are available from Arakawa Chemical (U.S.A.) Incorporated. Of course, the present invention is not limited to use of such tackifying resins, and other tackifying resins that are compatible with the other components of the composition and that can withstand the processing conditions may also be used.

A structure that utilizes such an elastomer as a substrate on which to deposit a novel coating has the advantage of having an inexpensive core material to provide the structural characteristics and the novel coating to provide absorbency and lubricity. Such fibers can be formed into either woven or nonwoven fabrics.

Woven and nonwoven fabrics having a coating or filling of the present coating offer a number of advantages. For example woven gauze having a subject hydrogel coating provides high absorbency coupled with high integrity and non-adherence to the wound.

Surge material can be coated on one side to provide a structure having gradient hydrophilicity and absorbency. In addition, if desired, a hydrophilic/absorbent adhesive can be used to secure the surge to the retention layer to eliminate gaps and assure intimate contact.

In an alternative embodiment, surge material could simply be saturated with the coating solution to provide a pseudo-foam wound dressing having the benefit of being a low cost alternative to foam, but with high absorbency.

It is believed that useful articles that can act as substrates for the novel coating include any tampon applicator known in the art. Prior art applicators having a typical “tube and plunger” type arrangement may be plastic, paper, or other suitable material. Additionally, a “compact” type applicator is also suitable.

### General Procedures

In the examples all percentages are given on a weight basis unless otherwise indicated.

All molecular weights are given on a weight average basis unless otherwise indicated.

Water absorbency under unrestrained conditions (free swell) of copolymers that can be used in the subject coatings was tested according to the following method. A sample of film or resin pellet with a weight of 30 to 50 milligrams is weighed in the dry state to the nearest tenth of a milligram. The test sample is place in a 500 ml bottle to which 100 ml of distilled water is added. The bottle is shaken on a laboratory shaker for 30 minutes at room temperature. The contents of the bottle are filtered under vacuum with a Beuchner funnel using Whatman 55 mm filter paper. The swollen sample is removed from the filter paper and weighed to the nearest milligram. Gram per gram uptake is calculated as the wet weight of recovered (insoluble) material, divided by the initial dry weight of the sample, minus 1. Generally, the average of 5 replicates is reported. A similar procedure is used with 0.9% saline replacing distilled water.

Uptake of simulated menses or saline solution was determined for the coatings as follows: Samples of the copolymer to be tested were weighed and then soaked in 20 ml of saline or menses simulant composed of swine blood of controlled hemocrit with albumin added to simulate the visco-elastic properties of menses. The samples were soaked for 30 minutes, removed, the excess fluid was drained from the surface, and the wet samples were then weighed. This weight is used to calculate the saturated uptake. The sample is then placed under a pressure of 0.5 psi and then weighed again to determine the blotted uptake after expressed fluid has drained from the sample. The amount of fluid that remains in the sample is used to calculate the fluid uptake at 0.5 psi.

### EXAMPLE 1

This example illustrates the synthesis of a graft copolymer from poly(ethylene oxide) engrafted with 3-(trimethoxysilyl) propyl methacrylate that is useful in the coatings of the present invention.

Polyethylene oxide (“PEO”), supplied by Union Carbide under the name POLYOX Water Soluble Resins, was used. POLYOX WSR-205 having a molecular weight of about 600,000 g/mol was used in powder form. The reactive polar vinyl monomer used was 3-(trimethoxysilyl) propyl methacrylate supplied by Aldrich Chemical Company and manufactured by Dow Corning under the trade name, Dow Corning Z-6030 Silane. The peroxide initiator used was Varox DBPH, supplied by R.T. Vanderbilt Company, Inc.

The monomer is composed of two functional groups. The methacrylate function reacts with PEO after a free radical site is initiated with peroxide. The resultant modified PEO resin is still thermally processable as long as it is kept relatively dry. The crosslinking takes place from the other end of the molecule at the alkoxysilane function. The alkoxysilane is readily hydrolyzed into a more reactive silanol and the silanol condenses with another silanol to form a cross-linked network. Because the grafting monomer has three alkoxysilanes, each graft site is theoretically capable of forming three crosslinks. Use of this type of grafting monomer provides a modified resin, which, while kept relatively dry, can be fabricated into useful structures, and then, when exposed to humid air, become crosslinked. The result is a material that retains the versatility of thermal processability into a variety of structures along with the capability of using those structures for absorbency. This unusual combination of features is available because the crosslinked, hydrophilic network is generated after the structure is fabricated.

A bench-scale HAAKE twin-screw extruder was used. This unit contains a set of custom-made, counter-rotating conical twin screws. Screw Design for the HAAKE Extruder: A general characteristic description is provided in Table I since the exact dimensions may be proprietary to the extruder manufacturer.

TABLE 1
Extruder characteristics.

| Sections | Descriptions |
|---|---|
| Section 1: | A double flighted forward pumping section: Large screw lead |
| | (pitch) and a high helix angle |
| Section 2: | A double flighted forward pumping section: Screw pitch is |
| | smaller than Section 1 |
| Section 3: | A double flighted forward pumping section: Screw pitch is |
| | smaller than Section 2 |
| Section 4: | A double flighted and notched reversed pumping section |
| | One complete flight with notches |
| Section 5: | A double flighted notched forward pumping section Two |
| | complete flights |
| Section 6: | A double flighted forward pumping section Screw pitch is |
| | between sections 1 and 2. |

The die has two openings of 3 mm in diameter, which are separated by 10 mm. The strands were cooled in air and subsequently pelletized. The feed section was not heated, rather it was cooled by water. The extruder has three heating sections from the feeding section towards the die designated as Zone 1, Zone 2, and Zone 3. The die was designated as Zone 4.

The first reactive extrusion was done on a HAAKE twin screw extruder of 10/1 L/D with custom designed screws (described above) at a rate of 5 pounds per hour. The pelletized POLYOX 205 was metered into the throat of the extruder at a rate of 37.8 g/min with a K-Tron feeder. In the same manner, Varox DBPH peroxide was metered at a rate equivalent to 0.25 weight percent of the POLYOX 205 and the Z-6030 silane was metered in with an Eldex pump at a rate of 2 to 5 weight percent of the POLYOX 205. The temperature profile for the heating zones were 150°, 160°, 160°, and 170° C. The screw speed was 150 rpm. The strands were cooled in air using a fan-cooled conveyer belt. The solidified strands of the grafted POLYOX 205 were then pelletized using a Conair pelletizer.

The sample pellets from this experiment were stored under ambient conditions for four months and then under high humidity (33° C. and 80% relative humidity) for seven days. The resin samples were tested to determine the ultimate gel fraction according to the procedure described below. The gel fraction is the portion of the sample that is cross-linked and no longer soluble in water. The soluble fraction is equal to 1-(gel fraction).

### Gel Fraction Test

A sample of film or resin pellet with a weight of 30 to 50 milligrams is weighed in the dry state to the nearest tenth of a milligram. The test sample is place in a 500 ml bottle to which 100 ml of distilled water is added. The bottle is shaken on a laboratory shaker for 30 minutes at room temperature. The contents of the bottle are filtered under vacuum with a Beuchner funnel using Whatman 55 mm filter paper (catalogue # 1001 55) which was pre-dried at 60° C. and weighed to the nearest tenth of a milligram. The insoluble portion of the sample is dried along with the filter paper at 60° C. for two hours and then weighed to determine the dry weight of insoluble material.

Gel fraction or percent gel is taken as the dry weight of recovered (insoluble) material divided by the initial dry weight of the sample. Generally, the average of 5 replicates is reported in Table 2 below:

TABLE 2
Gel fraction in several samples of graft copolymer

| | Weight percent | Weight percent | Extruder Pressure | Gel |
|---|---|---|---|---|
| Sample | Z6030 | Varox DBPH | (psi) | Fraction |
| 1-1 | 0 | 0 | 530 | 0 |
| 1-2 | 2 | 0.15 | 330 | 0.91 |
| 1-3 | 5 | 0.25 | 430 | Not tested |

The addition of the monomer and peroxide initiator results in a reduction in extruder pressure compared to the control. The reduced pressure is indicative of reduced melt viscosity. This result indicates that the PEO has been modified into a form that is water-absorbent and not completely water-soluble like the control resin (sample 1-1).

### EXAMPLE 2

The following samples were prepared using the same method and extruder temperatures as described above in Example 1 and using the proportions of ingredients indicated in Table 3 below. Since the first sample resulted in low extruder pressure, the temperatures were reduced to bring the extruder pressure into the proper range.

TABLE 3
Production parameters for extrusion/reaction.

| | | Weight % | | |
|---|---|---|---|---|
| | Weight % vinyl | Varox | Extruder | Comments, |
| Sample | triethoxy silane | DBPH | pressure | Observations |
| 2-1-a | 5 | .25 | 92 | Very low pressure, |
| | | | | temperatures |
| | | | | reduced to 120, |
| | | | | 130, 130, 140 |
| 2-1-b | 5 | .25 | 270 | Low melt viscosity |
| 2-2 | 2 | .15 | 350 | Low melt viscosity |
| 2-3 | 0 | 0 | 700 | P205 control, high |
| | | | | pressure, rough |
| | | | | strands |

Pellets from samples 2-1-b, 2-2 and 2-3 were stored for approximately ten weeks under laboratory conditions, exposed to ambient humidity. All three samples aged under these conditions, dissolved in water after standing overnight.

The resin samples prepared with triethoxy vinyl silane remained water-soluble. This result suggests that this monomer was not grafted onto P205 under the same conditions that were effective for grafting Z6030. The significant reduction in melt pressure and melt viscosity indicates that chain scission of the PEO was occurring rather than grafting. Different conditions or initiators may be needed to induce grafting between PEO and triethoxy vinyl silane.

### EXAMPLE 3

A third reactive extrusion experiment was conducted to evaluate the effect of higher addition level of the Z6030 monomer along with proportionately higher addition of the peroxide initiator. The same screw design and production rate as Example 1 was used. The pelletized POLYOX 205 was metered into the throat of the extruder at a rate of 37.8 g/minute with a K-Tron feeder. Dow Corning Z-6030 Silane was metered into the throat of the extruder with an Eldex pump at a rate of 3.78 g/minute, equivalent to ten weight percent of the POLYOX 205. In the same manner, Varox DBPH peroxide was metered at a rate equivalent to 0.40 weight percent of the POLYOX 205. A second code was run at five weight percent addition of Z6030 with Varox DBPH peroxide metered at a rate equivalent to 0.33 weight percent of the POLYOX 205. The temperature profile for the heating zones were 150°, 160°, 160°, and 170° C. The strands were cooled in air using a fan-cooler conveyor belt. The solidified strands of the grafted POLYOX 205 were then pelletized on a Conair pelletizer.

The sample descriptions and gel fraction results are shown in the Table 4 below. These gel fraction results were obtained after six months at ambient conditions followed by one week at 80% relative humidity.

TABLE 4
Gel fractions generated in samples of a graft copolymer.

| | | | Extruder | |
|---|---|---|---|---|
| | | Weight % Varox | pressure | |
| Sample | Weight % Z6030 | DBPH | (psi) | Gel Fraction |
| 3-1 | 10 | .40 | 420 | .92 |
| 3-2 | 5 | .33 | 450 | .95 |

These results indicate that five percent Z6030 is sufficient monomer to provide a nearly crosslinked, PEO gel.

### EXAMPLE 4

This example illustrates the formation of a coating of the novel graft copolymer on a plastic tampon applicator.

A modified poly(ethylene oxide) was produced from poly(ethylene oxide) (Polyox WSR-205 resin, available from Union Carbide) grafted with 3% by weight of methacryloxypropyl trimethoxy silane (Dow Corning Z-6030 Silane, available from the Dow Corning Co.) in the presence of a peroxide initiator (Varox DBPH, supplied by R.T. Vanderbilt Co., Inc.) as described in Examples 1-6, above. A 2% by weight solution of this material was prepared by the addition of the dry copolymer to a suitable amount of water with stirring at room temperature. A plastic tampon applicator was immersed in the solution, removed, and allowed to dry overnight at room temperature.

### EXAMPLE 5

This example illustrates the formation of a lubricious, absorbent coating on a cardboard tampon applicator.

A modified poly(ethylene oxide) was produced from poly(ethylene oxide) (Polyox N-80 resin, available from Union Carbide) grafted with 6% by weight of methacryloxypropyl trimethoxy silane (Dow Corning Z-6030 Silane, available from the Dow Corning Co.) in the presence of a peroxide initiator (Varox DBPH, supplied by R.T. Vanderbilt Co., Inc.) as described in Examples 1-6, above. A 3% by weight solution of this material was prepared by the addition of the dry copolymer to a suitable amount of water with stirring at high shear using an Ultra Turrax mixer (available from IKA Laboratory Technology with offices in Wilmington, N.C.) at room temperature. This solution was used to spray a cardboard tampon applicator. The applicator was allowed to dry overnight at room temperature.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of forming a coating on a tampon applicator, the method comprising contacting said tampon applicator with a copolymer comprising a water soluble base polymer having graft polymerized thereto in a non-terminal position an organic moiety that includes a group that reacts with water to form a silanol group; and curing the copolymer to form a coating comprising the crosslinked copolymer on the article.

2. The method according to claim 1, where the group that reacts with water to form a silanol group is a trialkoxy silane functional group.

3. The method according to claim 1, wherein said contacting comprises applying a film containing un-crosslinked copolymer to the tampon applicator.

4. The method according to claim 3, wherein said applying is carried out under substantially water-free conditions.

5. The method according to claim 4, wherein the film substantially covers the exterior surface of the tampon applictor.

6. The method according to claim 5, wherein the curing step comprises contacting the film with water.

7. The method according to claim 1, wherein the contacting step comprises forming a solution of the copolymer in a solvent and placing a film of solution on the tampon applicator.

8. The method according to claim 7, wherein the solvent is water, an organic solvent, or a mixture thereof.

9. The method according to claim 8, wherein the solvent is water.

10. The method according to claim 7, wherein placing a film of solution on the tampon applicator comprises dipping, spraying, printing, painting, or immersing the tampon applicator with or in the solution.

11. The method according to claim 10, wherein curing the copolymer to form a coating of the cross-linked copolymer comprises removing solvent from the copolymer.

12. The method according to claim 11, wherein removing solvent from the copolymer comprises evaporating the solvent.

13. The method according to claim 12, wherein the evaporation comprises drying.

14. A coating on a tampon applicator, the coating comprising a crosslinked hydrogel that includes a copolymer comprising water soluble base polymers having graft polymerized thereto organic moieties that react with water to form a silanol group, the copolymer being crosslinked through the silanol groups of the organic moieties to form a coating that is absorbent, lubricious and substantially non-water soluble.

15. The coating according to claim 14, wherein the copolymer comprises the organic moieties in an amount that is within a range of about 0.5 to about 10 percent by weight of the water soluble base polymer.

16. The coating according to claim 15, wherein the coating is transparent.

17. The coating according to claim 16, wherein the coating is resistant to fogging.

18. The coating according to claim 14, wherein the coating is anti-thrombogenic.

19. The coating according to claim 15, wherein the coating comprises, in addition, a releasable component.

20. The coating according to claim 19, wherein the releasable component is selected from the group consisting of therapeutic agents, bioactive agents, antibiotics, bactericides, fungicides, drugs, growth factors, peptides, proteins, enzymes, emollients, antiseptics, anti-oxidants, wetting agents, and mixtures thereof.
